(19) United States
(12) Patent Application Publication
(10) Pub. No.: US 2026/0202653 A1
(43) Pub. Date: Jul. 16, 2026

(54) ILLUMINATOR FOR AN OPHTHALMIC SYSTEM

(71) Applicant: Alcon Inc., Fribourg (CH)

(72) Inventors: Kai Hofmann, Blankenfelde-Mahlow (DE); Martin Eil, Berlin (DE)

(21) Appl. No.: 19/442,267

(22) Filed: Jan. 7, 2026

Related U.S. Application Data
(60) Provisional application No. 63/745,856, filed on Jan. 16, 2025.

(51) Int. Cl. G02B 21/00; G02B 21/36; G02B 27/00

(52) U.S. Cl. CPC G02B 21/0032; G02B 21/0012; G02B 21/008; G02B 21/361; G02B 21/368; G02B 27/0093

(57) ABSTRACT

In certain embodiments, a system configured to illuminate an eye includes a pattern illuminator and an illuminator computer. The pattern illuminator provides an illumination pattern directed towards the anterior surface of the eye. The anterior surface of the eye reflects the illumination pattern as a reflected illumination pattern. The illuminator computer receives, via a wireless communication link, a set of instructions configured to coordinate the illumination pattern with a device of one or more devices of an ophthalmic system. The illuminator computer instructs the pattern illuminator to provide the illumination pattern according to the set of instructions to coordinate the illumination pattern with the device of the ophthalmic system.

### FIELD

Embodiments of the present disclosure relate to an illuminator for an ophthalmic system.

### BACKGROUND

Reflection-based diagnostic systems include an illuminator that directs light in a pattern towards an eye, which reflects the light. The reflected light may be analyzed to describe a feature of the eye, such as the corneal topography of the eye. For example, a Placido disc system directs light in a Placido disc pattern, which is reflected by the anterior surface of the eye. The reflected light can provide information about the curvature of the anterior surface of the eye.

### SUMMARY

In certain embodiments, a system configured to illuminate an eye includes a pattern illuminator and an illuminator computer. The pattern illuminator provides an illumination pattern directed towards the anterior surface of the eye. The anterior surface of the eye reflects the illumination pattern as a reflected illumination pattern. The illuminator computer receives, via a wireless communication link, a set of instructions configured to coordinate the illumination pattern with one or more device(s) of an ophthalmic system. The illuminator computer instructs the pattern illuminator to provide the illumination pattern according to the set of instructions to coordinate the illumination pattern with the device(s) of the ophthalmic system.

One or more embodiments may include one, more than one, or all of the following features.

The device may be a camera system that captures an image of the reflected illumination pattern. The illuminator computer may instruct the pattern illuminator to provide the illumination pattern when the camera system is capturing the image of the reflected illumination pattern.

The device may be an eye-tracker that tracks the movement of the eye. The illuminator computer may instruct the pattern illuminator to not provide the illumination pattern when the eye-tracker is tracking the movement of the eye.

The device may be an eye-tracker that tracks the movement of the eye. The illuminator computer may instruct the pattern illuminator to not provide the illumination pattern when the eye-tracker is providing an eye-tracking light.

The device may be a laser system that directs a laser beam towards the eye. The illuminator computer may instruct the pattern illuminator to not provide the illumination pattern when the laser system is directing the laser beam towards the eye.

The set of instructions may include a notification that the device is operating. The illuminator computer may instruct the pattern illuminator to not provide the illumination pattern in response to the notification that the device is operating.

The set of instructions may include a notification that the device is operating. The illuminator computer may instruct the pattern illuminator to provide the illumination pattern in response to the notification that the device is operating.

The devices may include a camera system that captures an image of the reflected illumination pattern and an alignment detector that detects that the eye is aligned with the ophthalmic system. The illuminator computer may instruct the pattern illuminator to provide the illumination pattern when the camera system is capturing the image of the reflected illumination pattern, and the alignment detector is detecting that the eye is aligned with the ophthalmic system.

The devices may include a camera system that captures an image of the reflected illumination pattern, an alignment detector that detects that the eye is aligned with the ophthalmic system, and a distance measurement system that measures the distance to the eye. The illuminator computer may instruct the pattern illuminator to provide the illumination pattern when the camera system is capturing the image of the reflected illumination pattern, the alignment detector detects that the eye is aligned with the ophthalmic system, and the distance measurement system is measuring the distance to the eye.

The illuminator computer may include a transceiver that receives, via the wireless communication, the set of instructions.

The illuminator computer may communicate, via the wireless communication, with a system computer of the ophthalmic system.

The pattern illuminator may include one or more illuminator rings, where each illuminator ring may provide a circular illumination pattern.

The pattern illuminator may include pixel illuminators, where each pixel illuminator may provide light. The illuminator computer may turn on at least a subset of the plurality of pixel illuminators to yield the illumination pattern.

The system may include the ophthalmic system. The ophthalmic system may generate an image of the reflected illumination pattern, perform an analysis of the image of the reflected illumination pattern, and generate a description of the eye according to the analysis of the image of the reflected illumination pattern. The description of the eye may describe the curvature of the anterior surface of the eye and/or may include a topographic image that describes the curvature of the anterior surface of the eye.

The system may include a display device that displays a graphical user interface that can receive an input for the set of instructions. The graphical user interface may include an illuminator pattern selector that receives a selection of a pattern for the illumination pattern. The graphical user interface may include a manual control selector that receives a manual control selection to provide the illumination pattern in response to a manual command. The graphical user interface may include a device selector and a turn on / turn off selector. The device selector receives a selection of the device to be coordinated with the illuminator system. The turn on / turn off selector receives a selection to coordinate the illumination pattern with the device.

### BRIEF DESCRIPTION OF THE DRAWINGS

FIGS. 1A and 1B illustrate an example of an ophthalmic system with an illuminator system configured to provide an illumination pattern, according to at least one embodiment described in the present disclosure;

FIGS. 2A and 2B illustrate an example of an illuminator system coupled to a microscope, according to at least one embodiment described in the present disclosure;

FIG. 3 illustrates an example of a computer system, according to at least one embodiment described in the present disclosure;

FIGS. 4A and 4B illustrate examples of graphical user interfaces (GUIs) that may be used to configure an illuminator system, according to at least one embodiment described in the present disclosure;

FIG. 5 illustrates an example of a method of coordinating illumination of a light pattern with a device of an ophthalmic system, according to at least one embodiment described in the present disclosure;

FIG. 6 illustrates an example of a method of coordinating a pattern illuminator and a camera to capture an image of an eye, according to at least one embodiment described in the present disclosure;

FIG. 7 illustrates an example of a method of coordinating a pattern illuminator, a camera, and an alignment detector to capture an image of an eye, according to at least one embodiment described in the present disclosure; and

FIG. 8 illustrates an example of a method of coordinating a pattern illuminator, a camera, an alignment detector, and a distance measurement system to capture an image of an eye, according to at least one embodiment described in the present disclosure.

### DESCRIPTION OF EXAMPLE EMBODIMENTS

Referring now to the description and drawings, one or more example embodiments of the disclosed apparatuses, systems, and methods are shown in detail. The description and drawings are not intended to be exhaustive or otherwise limit the claims to the specific embodiments shown in the drawings and disclosed in the description. Although the drawings represent possible embodiments, the drawings are not necessarily to scale and certain features may be simplified, exaggerated, removed, or partially sectioned to better illustrate the embodiments.

Known reflection-based systems include an illuminator that is coupled to a reflection-based system with a cable system. However, the cabled system requires inconvenient cable management and restricts positioning of the system. Accordingly, the present disclosure relates to an illuminator that is wirelessly coupled to the reflection-based system. The illuminator may be controlled via a wireless communication link.

Certain embodiments of the present disclosure may provide improvements over known iterations of illuminators. For example, the illuminator may be attached to an existing ophthalmic system, e.g., an ophthalmic microscope, to allow the existing ophthalmic system to perform reflection-based analysis. As another example, the illuminator may communicate wirelessly with an ophthalmic system, reducing the use of cumbersome wired connections. As another example, a graphical user interface (GUI) may be used to program the illumination pattern provided by the illuminator. As another example, a GUI may be used to coordinate operation of the illumination pattern with another device.

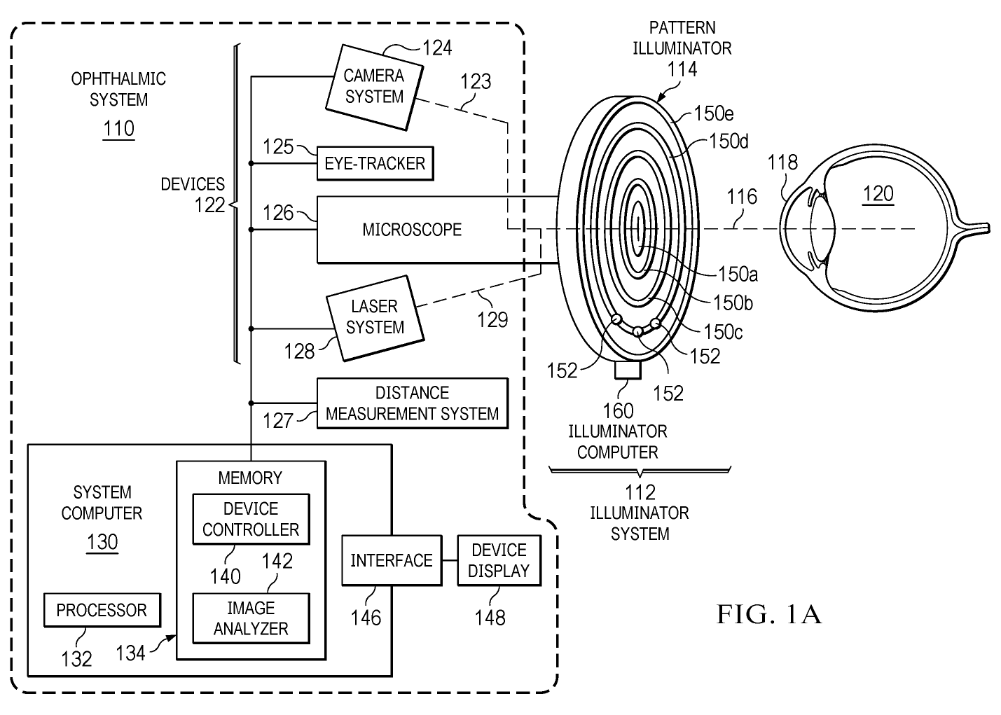

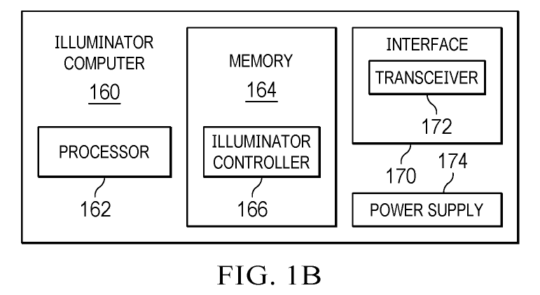

FIGS. 1A to 1B illustrate an example of an ophthalmic system 110 with an illuminator system 112 configured to provide an illumination pattern that is reflected by the anterior surface 118 of an eye 120, according to at least one embodiment described in the present disclosure. In FIG. 1A, the ophthalmic system 110 has an optical axis 116 that is designed to align with an axis 116 of the eye 120 (e.g., the visual axis or the optical axis) when the eye 120 is aligned with the ophthalmic system 110. For ease of explanation, the optical axis 116 may define a z-axis of a coordinate system of the ophthalmic system 110. The z-axis may define one or more xy-planes that are orthogonal to the z-axis.

In the example, the ophthalmic system 110 includes devices 122 and a system computer 130. The devices 122 may include a camera system 124, an eye-tracker 125, a microscope 126, a distance measurement system 127, and/or a laser system 128. The camera system 124 has a camera optical axis 123, which may be aligned with the optical axis 116 of the ophthalmic system 110. The laser system 128 has a laser optical axis 129, which may be aligned with the optical axis 116 of the ophthalmic system 110.

The system computer 130 includes a processor 132, a memory 134 (which stores applications such as a device controller 140 and an image analyzer 142), and an interface 146 that includes a display device 148. The illuminator system 112 includes a pattern illuminator 114 and an illuminator computer 160. The pattern illuminator 114 includes illuminator rings 150 (150a to 150e), which may have illuminator elements 152. In FIG. 1B, the illuminator computer 160 includes a processor 162, a memory 164 (which may store an application such as an illuminator controller 166), an interface 170 (which may include a transceiver 172), and a power supply 174.

As an example of an overview of operation, the pattern illuminator 114 provides an illuminated light pattern directed towards the anterior surface 118 of an eye 120. The anterior surface 118 reflects the light pattern. The reflected light pattern may be analyzed to, e.g., describe the topography of the anterior surface 118 of the eye 120. In certain examples, the illuminator computer 160 receives, via a wireless communication, a set of instructions designed to coordinate the illumination of the light pattern with a device of the ophthalmic system 110. The illuminator computer 60 instructs the pattern illuminator 114 to provide the illumination of the light pattern according to the set of instructions to coordinate the illumination with the device.

The ophthalmic system 110 may be any suitable medical device that performs a medical procedure, such as a surgical procedure and/or a diagnostic procedure. Examples of ophthalmic diagnostic procedures include corneal topography, corneal keratometry, intraocular pressure measurement, tear film assessment, and/or eye tissue imaging procedures. Examples of ophthalmic surgical procedures include cataract, refractive, vitreoretinal, and/or other ophthalmic procedures. In certain embodiments, the ophthalmic system 110 may be an ophthalmic diagnostic system that performs diagnostic procedures on human eyes.

Turning to the parts of the ophthalmic system 110, in FIG. 1A, the microscope 126 may be an ophthalmic surgical microscope that facilitates magnified viewing of the eye 120 during a surgical procedure and/or a diagnostic procedure. The microscope 126 may generally include eyepieces, a relay lens, magnifying optics, focusing optics, and/or an objective lens. The microscope 126 may provide an optical image and/or a digital image of the eye 120 for viewing via eyepieces and/or the display device 148.

The pattern illuminator 114 may be coupled to the microscope 126 via any suitable mechanical, electromagnetic, and/or magnetic coupling. The pattern illuminator 114 may be coupled to the microscope 126 during the manufacturing of the microscope 126 or after the microscope 126 has been manufactured and/or marketed. The pattern illuminator 114 may be fixed to the microscope 126 such that the user of the microscope 126 cannot readily remove the pattern illuminator 114 or may be removably coupled to the microscope 126 such that the user of the microscope 126 can readily remove the pattern illuminator 114.

The pattern illuminator 114 directs light in a pattern (e.g., a Placido pattern) towards the anterior surface 118 of the eye 120. The pattern may be any suitable pattern that can be reflected from the eye 120 to detect features of the eye 120. For example, the pattern may include none, one, or more of the following: (1) concentric rings, of the same or different thicknesses, equally or unequally spaced; (2) a pattern of dots, dashes, and/or other figures, of the same or different sizes, equally or unequally spaced; and/or (3) a series of lines, of the same or different thicknesses, equally or unequally spaced.

In certain embodiments, the pattern may be a Placido pattern. As an example, the Placido pattern may have any suitable number of concentric rings, e.g., 3 to 15 concentric rings, such as 3 to 5, 5 to 10, and/or 10 to 15 concentric rings. As another example, the Placido pattern may have any suitable number of spots (e.g., 4 to 50 spots, such as 4 to 10, 10 to 20, 20 to 30, 30 to 40, and/or 40 to 50 spots) disposed between adjacent rings of at least a subset of the concentric rings. As another example, a concentric ring of the Placido pattern may have a distinguishing feature that distinguishes the ring from an adjacent ring.

The pattern illuminator 114 may comprise any suitable arrangement of one or more light source(s) that can illuminate the anterior surface 118. In certain embodiments, the pattern illuminator 114 includes one or more illuminator ring(s) 150 (150a to 150e). An illuminator ring 150 may provide any suitable circular pattern of light. For example, the circular pattern may comprise dots, dashes, and/or other lines, or the circular pattern may be a solid circular line. Different illuminator rings 150 may provide the same or different pattern(s). In certain embodiments, the pattern illuminator 114 includes illuminator elements 152, such as pixel illuminators arranged in a ring or an array, where each pixel provides a pixel of light. The pixels are combined to yield the pattern. The illuminator computer 160 may turn on or off particular pixel illuminators to yield a specific pattern.

The illuminator computer 160 controls the illumination of the pattern illuminator 114. The processor 162 accesses the illuminator controller 166 (stored in the memory 164) to control the pattern illuminator 114 according to instructions. The instructions may be stored in memory 164 and/or received from the system computer 130 of the ophthalmic system 110. The transceiver 172 may be used to communicate with the system computer 130 using any suitable communication network (e.g., Zigbee, Bluetooth, or WiFi). For example, the transceiver 172 may receive information (e.g., instructions) from the system computer 130 and/or may send information (e.g., operational notifications) to the system computer 130. In certain embodiments, the power supply 174 provides power to provide the illumination. Examples of the power supply 174 include a battery (which may be rechargeable). In certain embodiments, the pattern illuminator 114 may receive power from another source, e.g., the ophthalmic system 110 or an electrical outlet.

The ophthalmic system 110 may include any other suitable devices 122. In the example, the devices 122 include the camera system 124, the eye-tracker 125, and/or the laser system 128. The camera system 124 may include one or more camera(s) or other optical sensor(s) that can generate an image of the eye 120. In general, a digital camera or other optical sensor detects light from an object and generates a signal in response to the light. The signal carries digital image data that can be used to generate the digital image of the object. A camera may have any suitable frame rate, e.g., 1 to 2000 frames per second, such as 1 to 50, 50 to 200, 200 to 500, 500 to 1000, 1000 to 1500, and/or 1500 to 2000 frames per second. Examples of digital cameras include a charge-coupled device (CCD) camera, a video camera, a complementary metal-oxide semiconductor (CMOS) sensor (e.g., active-pixel sensor (APS)), a line sensor, and an optical coherence tomography (OCT) camera.

The camera system 124 may have any suitable number (e.g., one, two, three, or more) of camera(s) arranged in any suitable manner. In certain embodiments, the camera system 124 may include any suitable number of on-axis and/or off-axis cameras. An on-axis camera has an optical axis that substantially coincides with the axis 116, and an off-axis camera has an optical axis that is at an angle (e.g., a value within the range of 1 to 10, 10 to 30, 30 to 40, or 40 to 60 degrees) with the axis 116. In certain embodiments, system 110 may include only one camera in the camera system124 that moves to different positions (e.g., on-axis and/or off-axis) to operate as different cameras, such that the one camera is considered multiple cameras as it can operate and provide the same data as multiple cameras.

The eye-tracker 125 tracks the movement of the eye 120. In certain embodiments, the eye-tracker 125 includes a camera that captures images of the eye 120 to track the movement of the eye 120. Examples of suitable cameras are described with reference to the camera system 124. A computer of the eye-tracker 125 may identify a feature of the eye 120 (e.g., pupil, iris detail, or blood vessel) in the images and track the movement of the feature to track the movement of the eye 120. In some embodiments, the eye-tracker 125 may include any system that processes images captured by the camera system 124, for example, as a program stored on the memory 134.

The distance measurement system 127 measures the distance in the z-direction to the eye 120, e.g., to the anterior surface 118 of the eye 120. In certain embodiments, the distance measurement system 127 may include light diodes that direct light beams at different incident angles to the anterior surface 118 to form light spots at the anterior surface 118. When the eye 120 is at a predetermined distance from the ophthalmic system 110, the light spots may be at a specific relative geometric relationship to one another, indicating that the eye 120 is at the predetermined distance. For example, when the eye 120 is at the proper distance for a procedure, the light spots may coincide at the same point, indicating that the eye 120 is at the proper distance. In certain embodiments, the image analyzer 142 of the system computer 130 may be regarded as part of the distance measurement system 127. For example, the image analyzer 142 may determine whether the light spots indicate that the eye 120 is at the predetermined distance, e.g., whether the light spots coincide. The image analyzer 142 may determine whether the distance measurement was successful, e.g., whether the light spots indicated that the eye 120 is at the predetermined distance.

The laser system 128 may direct a laser beam towards the eye 120 to, e.g., perform a surgical procedure. In certain embodiments, the laser system 128 includes a laser source that generates the laser beam and a scanner that guides the laser beam. One or more optical device(s) direct the laser beam towards a focusing objective, which directs the laser beam towards the eye 120. The laser beam may have any suitable pulse duration, such as in the order of nanoseconds, picoseconds, femtoseconds, or attoseconds. The laser beam may have any suitable wavelength, such as in the range of 150 nanometers (nm) to 20 micrometers (µm). Examples of ranges include the ultraviolet (e.g., in the range of 180 to 400 nm, such as 190 to 195 nm or 345 to 355 nm), visible, or infrared wavelength (e.g., in the range of 750 to 1250 or 1250 to 1500 nm). The laser beam may process material in any suitable manner, e.g., ablate, incise, or photo-disrupt the material.

The system computer 130 includes the processor 132, the memory 134 (which stores applications such as the device controller 140 and the image analyzer 142), and the interface 146 with the display device 148. The device controller 140 sends instructions to one or more device(s) 122 to perform the operations of the one or more device(s) 122. The device controller 140 may also send instructions to the illuminator computer 160 to perform the operations of the pattern illuminator 114. In certain embodiments, the system computer 130 may instruct the pattern illuminator 114 to provide the light pattern in a manner that is coordinated with other operations and/or devices 122 of the system 110, as described herein.

The image analyzer 142 analyzes images from a camera, e.g., a camera of the camera system 124 and/or a camera of the eye-tracker 125. In certain embodiments, the image analyzer 142 analyzes images that the camera system 124 generated of the actual illumination pattern reflected by the eye 120 to provide a description of, e.g., the anterior surface 118 of the eye 120. In the embodiments, the image analyzer 142 compares the actual reflected pattern to an expected reflected pattern, e.g., a pattern expected to be reflected from an emmetropic eye. The image analyzer 142 may detect a deviation (or distortion) of the actual pattern from the expected pattern, which may be caused by a difference between the anterior surface 118 of the eye 120 and the anterior surface of the emmetropic eye. In response to the comparison, the image analyzer 142 may generate a description of the curvature of the anterior surface 118 of the eye 120, e.g., a topographic image of the eye 120.

In certain embodiments, the image analyzer 142 may assess the quality of an image of the eye 120. In the embodiments, the image analyzer 142 may analyze any distortions and/or degradations of the image to verify if the image satisfies image quality requirements. For example, the image analyzer 142 may check whether the reflected pattern of light can be detected in the image.

In certain embodiments, the image analyzer 142 may operate as an alignment detector and may analyze an image of the eye 120 to determine whether the eye 120 is aligned relative to the ophthalmic system 110. For example, the image analyzer may detect a feature of the eye (e.g., the pupil, the iris, or blood vessels) to determine if the eye 120 is in the aligned location. In certain embodiments, the image analyzer 142 may provide an overlay (e.g., an overlay of the eye feature) that can guide a user to align the eye 120.

In certain embodiments, the system computer 130 and/or the illuminator computer 160 may provide instructions that instruct the pattern illuminator 114 to provide the light pattern in a manner that is coordinated with other operations and/or devices 122 of the system 110. In the embodiments, the system computer 130 sends instructions to the illuminator computer 160, and the illuminator computer 160 provides the light pattern according to the instructions. Alternatively or additionally, the illuminator computer 160 has instructions stored in the memory 164 of the illuminator computer 160, and the illuminator computer 160 provides the light pattern according to the instructions.

In certain embodiments, the instructions instruct the pattern illuminator 114 when to provide (e.g., turn on or activate) and/or when to not provide (e.g., turn off or deactivate) illumination of the light pattern. For example, the instructions may instruct the pattern illuminator 114 turn on (or turn off) the illumination in response to receiving the instructions from, e.g., the system computer 130.

The instructions may coordinate the pattern illuminator 114 with one or more device(s) 122 of the ophthalmic system 110, such as with the operational state (e.g., on, standby, and/or off) of the device(s). In certain embodiments, the instructions instruct the pattern illuminator 114 to provide or not provide illumination of the light pattern when one or more device(s) 122 are operating or not operating. For example, the instructions instruct the pattern illuminator 114 to provide the illumination when the camera system 124 is capturing the image of the reflected pattern. As another example, the instructions instruct the pattern illuminator 114 to not provide the illumination when the eye-tracker 125 is tracking the movement of the eye 120. As yet another example, the instructions instruct the pattern illuminator 114 to not provide the illumination when the eye-tracker 125 is providing eye-tracking light. As yet another example, the instructions instruct the pattern illuminator 114 to not provide the illumination when the laser system 128 is directing a laser beam towards the eye 120.

In some embodiments, the instructions to the pattern illuminator 114 and/or the other devices may be interleaved. For example, the system computer 130 may cycle instructions to the camera system 124 in conjunction with the pattern illuminator 114 (including any known or detected offsets for lag or delay in processing of instructions, turning on illumination, capturing images by the camera system 124, etc.) with instructions to the eye-tracker 125 to illuminate the eye and track the position or focus of the eye and/or with instructions to the laser system 128 to direct a laser towards the eye 120. In these and other embodiments, by interleaving or cycling through the various components of the ophthalmic system 110, the anterior surface 118 of the eye 120 may be monitored even during a procedure, and the procedure may be updated using the determined profile of the anterior surface 118.

In certain embodiments, the instructions include a notification indicating the operational state (e.g., on, standby, and/or off) of a device. For example, the notification may indicate whether a device 122 is operating (e.g., is on) or not operating (e.g., is on standby or is off). In response, the pattern illuminator 114 provides or does not provide illumination of the light pattern. For example, the instructions indicate that the camera system 124 is capturing the image of the reflected pattern, and in response the pattern illuminator 114 provides the illumination. As another example, the instructions indicate that the eye-tracker 125 is tracking the movement of the eye 120 and/or is providing eye-tracking light, and in response the pattern illuminator 114 does not provide illumination. As yet another example, the instructions indicate that the laser system 128 is directing a laser beam towards the eye 120, and in response the pattern illuminator 114 does not provide illumination. In these and other embodiments, the pattern illuminator 114 may be added to an existing microscope 126 or other aspect of the ophthalmic system 110 such that by obtaining the notification of the statuses of the other components of the ophthalmic system 110, the pattern illuminator 114 can operate in tandem with those other components as if the pattern illuminator 114 was designed or manufactured as part of the ophthalmic system 110.

In certain embodiments, the instructions instruct the pattern illuminator 114 to illuminate a particular light pattern. For example, the instructions instruct the pattern illuminator 114 turn on (or turn off) one or more illuminator ring(s) 150 and/or one or more illuminator element(s) 152. Turning on (or turning off) different illuminator rings 150 and/or different illuminator elements 152 may yield different patterns. For example, turning on illuminator elements 152 that are closer together (e.g., less than 10 millimeters apart) may yield a solid line of illumination, and turning on illuminator elements 152 that are farther apart (e.g., more than 10 millimeters apart) may yield a dashed or dotted line of illumination. As another example, turning on adjacent illuminator rings 150, e.g., the illuminator ring 150a and the illuminator ring 150b, may yield a light pattern with rings that are closer together than turning on non-adjacent illuminator rings 150, e.g., the illuminator ring 150a and the illuminator ring 150c, and not turning on the illuminator ring 150b.

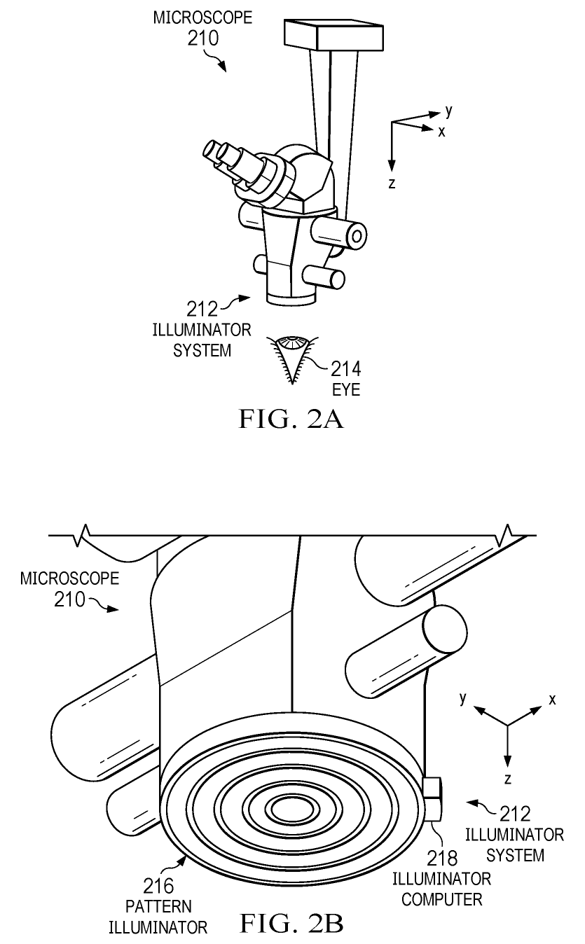

FIGS. 2A and 2B illustrate an example of an illuminator system 212 coupled to a microscope 210, according to at least one embodiment described in the present disclosure. The microscope 210 may be any suitable microscope, e.g., a surgical and/or diagnostic microscope. In the example, the microscope 210 is an ophthalmic microscope. In these and other embodiments, the illuminator system 212 may be similar or comparable to the illuminator system 112 and the microscope 210 may be similar or comparable to the ophthalmic system 110 and/or the microscope 126.

FIG. 2A illustrates a first view of the illuminator system 212 coupled to the microscope 210. In certain embodiments, a camera system (not shown) may be located between the optical head and the oculars of the microscope 210.

FIG. 2B illustrates a second view of the illuminator system 212 coupled to the microscope 210. The illuminator system 212 includes a pattern illuminator 216 and an illuminator computer 218. In these and other embodiments, the pattern illuminator 216 may be similar or comparable to the pattern illuminator 114 and the illuminator computer 218 may be similar or comparable to the illuminator computer 160.

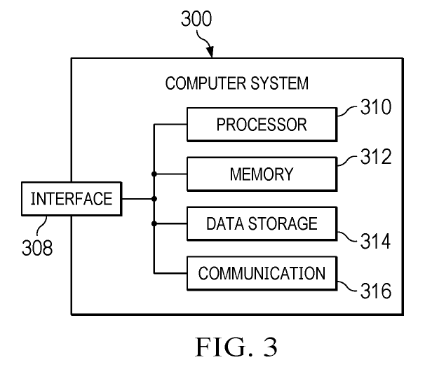

FIG. 3 illustrates an example of a computer system 300, according to at least one embodiment described in the present disclosure. The computer system 300 may include an interface 308, a processor 310, a memory 312, a data storage 314, and/or a communication subsystem 316, any or all of which may be communicatively coupled. Any or all of the computer system 300 may be implemented as computer hardware and/or software. Any or all of the computer systems described herein (e.g., a system computer and/or an illuminator computer) may be implemented as a computer system consistent with the computer system 300.

In the example, the interface 308 may receive input to the computer system 300 and/or send output from the computer system 300, and may be used to exchange information between, e.g., software, hardware, one or more peripheral devices, one or more users, and/or any suitable combinations of any of the preceding. A user interface is a type of interface that a user can utilize to communicate with (e.g., send input to and/or receive output from) the computer system 300. Examples of user interfaces include displays, Graphical User Interfaces (GUIs), touchscreens, foot pedals, keyboards, computer mouses (or mice), dials, joysticks, gesture sensors, microphones, and speakers.

Generally, the processor 310 may include any suitable special-purpose or general-purpose computer, computer entity, or processing device including various computer hardware or software modules and may be configured to execute instructions stored on any applicable computer-readable storage media. For example, the processor 310 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 3, the processor 310 may include any number of processors distributed across any number of network or physical locations that are configured to perform individually or collectively any number of operations described in the present disclosure.

The processor 310 may perform any suitable operations. In some embodiments, the processor 310 may interpret and/or execute program instructions and/or process data stored in the memory 312, the data storage 314, or the memory 312 and the data storage 314. In some embodiments, the processor 310 may fetch program instructions from the data storage 314 and load the program instructions into the memory 312. After the program instructions are loaded into the memory 312, the processor 310 may execute the program instructions, such as instructions to perform any of the methods disclosed herein, respectively.

The memory 312 and the data storage 314 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 310.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 310 to perform a certain operation or group of operations.

The communication subsystem 316 may include any component, device, system, or combination thereof that is configured to transmit, receive, and/or otherwise exchange information over a network in order to communicate with any suitable entity, such as with other devices at other locations or at the same location or even within the same system. The communication subsystem 316 may provide for communication among the devices described in the present disclosure, communication networks, computing devices, and other systems. For example, the communication subsystem 316 may allow the system 300 to communicate with other systems, such as other computing devices and/or networks. In some embodiments, the communication subsystem 316 may include a modem, a network card (wireless or wired), an optical communication device, an infrared communication device, a wireless communication device (such as an antenna), and/or chipset. Examples of communication subsystem 316 include a Bluetooth device, an 802.6 device (e.g., that can communicate with a Metropolitan Area Network (MAN)), a WiFi device, a WiMax device, cellular communication facilities, and/or the like.

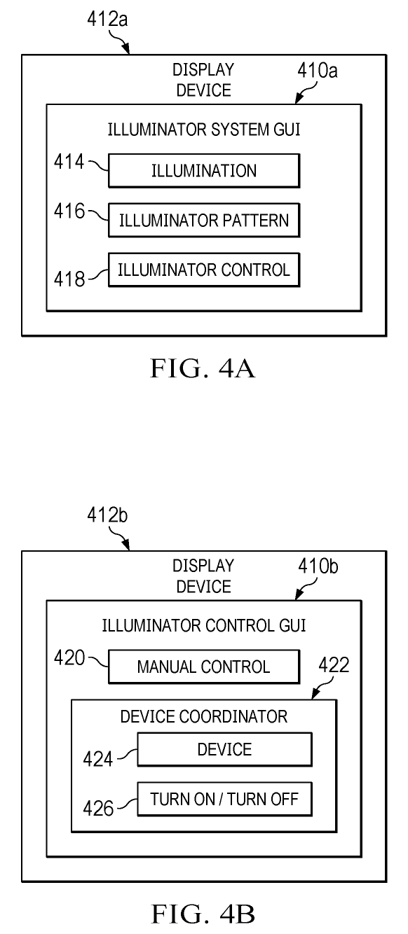

FIGS. 4A and 4B illustrate examples of graphical user interfaces (GUIs) 410 (410a and 410b) that may be used to configure an illuminator system, according to at least one embodiment described in the present disclosure. In certain embodiments, the GUIs 410a and/or 410b may be used to receive user input that is used to configure instructions for the illuminator system. In the examples, the GUIs 410 (410a and 410b) are displayed by display devices 412 (412a and 412b, respectively). The GUIs 410 may be used by any suitable computer, e.g., an ophthalmic system computer and/or an illuminator computer, which may display the GUI on a display device 412.

FIG. 4A illustrates an illumination GUI 410a that may be used to configure illumination for the illuminator system. The illumination GUI 410a includes one or more selector(s) 414, 416, and/or 418 used to set up illumination provided by the illuminator system. In the example, the illumination selector 414 may be used to select the intensity and/or the color of the illumination. For example, the illumination selector 414 may include a slider that adjusts the brightness between 100% and 0%. As an additional example, the illumination selector 414 may include a text box in which a user may enter a numerical value or a value of lux or lumens. As another example, the illumination selector 414 may include a series of selectable spots to select different colors of the illumination. As a further example, the illumination selector 414 may include a selectable color wheel or palette where different colors are selectable. The illuminator pattern selector 416 may be used to select the pattern of the illumination. For example, the illuminator pattern selector 416 may include a visual depiction of options for the pattern, each of which may be selectable by a user. In some embodiments, the selection of a given pattern may cause a corresponding change in color and/or intensity of the illumination. As a further example, the illuminator pattern selector 416 may include selectors to identify the gaps between rings, or gaps between line elements to create a dashed line, or other characteristics of the pattern. The illuminator control selector 418 may be used to configure when the illuminator system provides and/or does not provide the illumination pattern. For example, the illuminator control selector 418 may include a selector to toggle on or off interleaving the illuminator control signals. As a further example, the illuminator control selector 418 may include a toggle button or switch to turn the pattern illuminator on or off.

FIG. 4B illustrates an illuminator control GUI 410b that may be used to configure how the illuminator system provides and/or does not provide the illumination pattern. The illuminator system GUI 410a includes one or more selector(s) 420, 424, and/or 426 used to set up the illuminator system. In the example, the manual control selector 420 may be used to set up the illuminator system to provide illumination in response to a manual command, e.g., moving a physical selector (such as a button, joystick, and/or keyboard key) and/or selecting a computer icon. The device coordinator section 422 includes selectors that may be used to coordinate operation of the illuminator system with a device of an ophthalmic system. For example, the device selector 424 may be used to select the device to be coordinated with the illuminator system. The turn on / turn off selector 426 may be used to configure when the illuminator system provides or does not provide the illumination according to the operational state (e.g., on, standby, and/or off) of the selected device. Examples of such coordination are described herein.

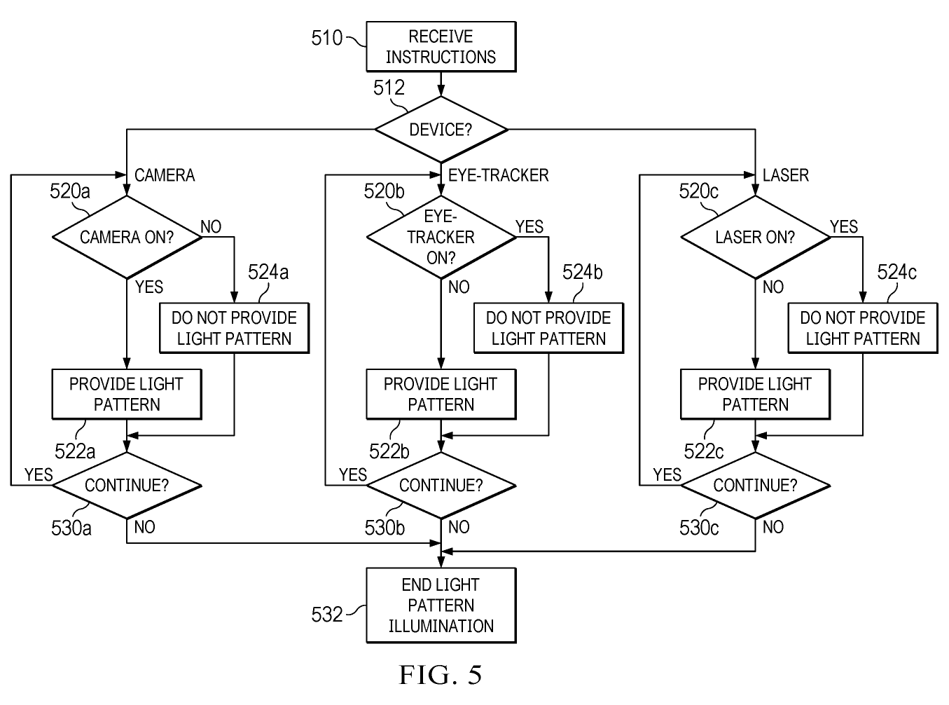

FIG. 5 illustrates an example of a method of coordinating illumination of a light pattern with one or more device(s) of an ophthalmic system, according to at least one embodiment described in the present disclosure. In the example, the device(s) may include a camera, an eye-tracker, and/or a laser system, and the pattern illuminator may be coordinated with the operational state (e.g., on, standby, and/or off) of the device(s). Any suitable computer may perform one or more blocks of the method. In the example, the computer may be an ophthalmic system computer and/or an illuminator computer.

At block 510, the computer receives instructions for coordinating illumination of a light pattern with one or more device(s).

At block 512, the device(s) of the instructions is determined. If the device(s) include the camera, the method proceeds to block 520a. If the device(s) include the eye-tracker, the method proceeds to block 520b. If the device(s) include the laser system, the method proceeds to block 520c.

At block 520a, the camera may be on. If the camera is on, the method proceeds to block 522a. If the camera is not on, the method proceeds to block 524a.

At block 522a, the illuminator system provides the light pattern.

At block 524a, the illuminator system does not provide the light pattern.

The illumination coordinated with the camera may continue at block 530a. If the illumination is to continue, the method returns to block 520a. If the illumination is not to continue, the method proceeds to block 532.

At block 520b, the eye-tracker may be on. If the eye-tracker is not on, the method proceeds to block 522b. If the eye-tracker is on, the method proceeds to block 524b.

At block 522b, the illuminator system provides the light pattern.

At block 524b, the illuminator system does not provide the light pattern.

The illumination coordinated with the eye-tracker may continue at block 530b. If the illumination is to continue, the method returns to block 520b. If the illumination is not to continue, the method proceeds to block 532.

At block 520c, the laser system may be on. If the laser system is not on, the method proceeds to block 522c. If the laser system is on, the method proceeds to block 524c.

At block 522c, the illuminator system provides the light pattern.

At block 524c, the illuminator system does not provide the light pattern

The illumination coordinated with the laser system may continue at block 530c. If the illumination is to continue, the method returns to block 520c. If the illumination is not to continue, the method proceeds to block 532.

At block 532, the light pattern illumination ends.

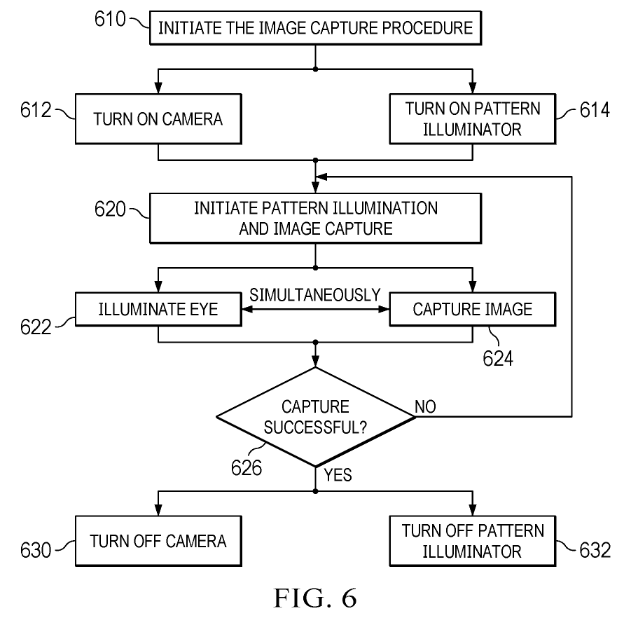

FIGS. 6 to 8 illustrate examples of methods of coordinating a pattern illuminator of an illumination system with a device of an ophthalmic system to capture an image of an eye, according to at least one embodiment described in the present disclosure. The image may be captured to, e.g., measure the topography of the eye. In the examples, the device(s) may be a camera of a camera system of the ophthalmic system and/or a distance measurement system of the ophthalmic system. However, in other examples, the device(s) may be an eye-tracker and/or a laser system of the ophthalmic system. Any suitable computer may perform one or more blocks of the methods. In the examples, an ophthalmic system computer may send instructions to the camera and/or the distance measurement system to perform one or more blocks, and/or an illuminator computer may send instructions to the pattern illuminator to perform one or more blocks.

FIG. 6 illustrates an example of a method of coordinating a pattern illuminator and a camera to capture an image of an eye, according to at least one embodiment described in the present disclosure.

At block 610, the image capture procedure is initiated. For example, a medical professional may initiate the image capture procedure to, e.g., measure the topography of the eye.

At block 612, the camera of the camera system is turned on. The camera may be turned on in preparation to capture an image of the eye.

At block 614, the pattern illuminator is turned on. The pattern illuminator may be turned on in preparation to illuminate the eye with the pattern.

At block 620, the pattern illumination and the image capture are initiated.

At block 622, the pattern illuminator illuminates the eye with the pattern.

At block 624, the camera captures an image of the eye illuminated with the pattern. Block 622 and block 624 may occur simultaneously. Additionally or alternatively, the capturing of the image and the illuminating the eye with the pattern may occur within a threshold amount of time with each other, such as within 0.25 milliseconds (ms), 0.5 ms, 0.75 ms, 1 ms, 5 ms, or any other threshold amount of time.

At block 626, the image capture may be successful. An image capture may be determined to be successful in any suitable manner. In certain embodiments, an image analyzer may check whether the image satisfies one or more image quality requirements to determine whether the image capture was successful. For example, a degree of sharpness of the image may be determined. As another example, a dark level, a light level, and/or a degree of contrast of the image may be determined. As an additional example, a resolution of the image may be determined. As yet another example, an amount of signal relative to an amount of noise (such as a signal-to-noise ratio (SNR)) may be determined. In the example, a SNR of 5:1 to 10:1 and/or 10:1 or greater may be acceptable. As yet another additional example, an amount of distortion of the image may be determined. If the image capture is not successful, the method returns to block 620. If the image capture is successful, the method proceeds to block 630.

At block 630, the camera is turned off.

At block 632, the pattern illuminator is turned off.

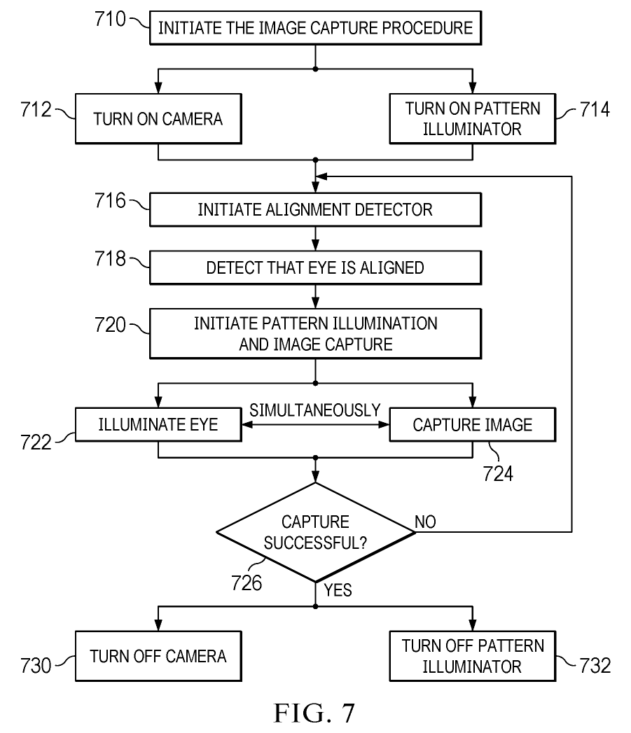

FIG. 7 illustrates an example of a method of coordinating a pattern illuminator, a camera, and an alignment detector to capture an image of an eye, according to at least one embodiment described in the present disclosure.

At block 710, the image capture procedure is initiated. For example, a medical professional may initiate the image capture procedure to, e.g., measure the topography of the eye.

At block 712, the camera of the camera system is turned on. The camera may be turned on in preparation to capture an image of the eye.

At block 714, the pattern illuminator is turned on. The pattern illuminator may be turned on in preparation to illuminate the eye with the pattern.

At block 716, the alignment detector is initiated. Any suitable alignment detector may be used. In certain embodiments, an image analyzer may analyze an image from the camera and/or an eye-tracker to detect whether the eye is aligned relative to the ophthalmic system, e.g., the eye is in a position where the camera can capture an image of the eye. In the embodiments, the image analyzer may provide an overlay, e.g., a pupil overlay, that can guide a user to align the eye, e.g., align the pupil of the eye with the pupil overlay. The image analyzer may then analyze an image of the eye to detect whether the eye is aligned, e.g., whether the pupil of the eye is aligned with the pupil overlay. In some cases, if the eye is not aligned, the overlay may provide a visual indication of a direction in which the ophthalmic system may move relative to the eye in order to align the eye. Additionally or alternatively, the patient may be moved relative to the ophthalmic system in order to align the eye.

At block 718, the eye is detected to be aligned. The eye may be detected to be aligned in any suitable manner. For example, an image analyzer may analyze an image of the eye to detect whether the pupil of the eye is aligned with a pupil overlay.

At block 720, the pattern illumination and the image capture are initiated.

At block 722, the pattern illuminator illuminates the eye with the pattern.

At block 724, the camera captures an image of the eye illuminated with the pattern. Block 722 and block 724 may occur simultaneously. Additionally or alternatively, the capturing of the image and the illuminating the eye with the pattern may occur within a threshold amount of time with each other, such as within 0.25 milliseconds (ms), 0.5 ms, 0.75 ms, 1 ms, 5 ms, or any other threshold amount of time.

At block 726, the image capture may be successful. An image capture may be determined to be successful in any suitable manner, e.g., in a manner described with reference to block 626 of FIG. 6. If the image capture is not successful, the method returns to block 716. If the image capture is successful, the method proceeds to block 730.

At block 730, the camera is turned off.

At block 732, the pattern illuminator is turned off.

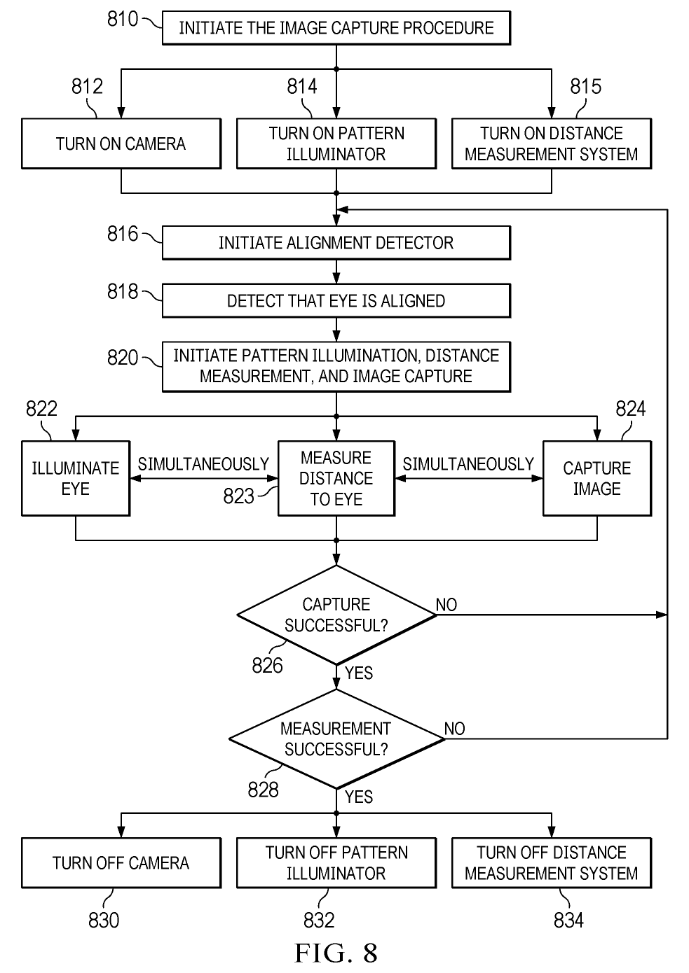

FIG. 8 illustrates an example of a method of coordinating a pattern illuminator, a camera, an alignment detector, and a distance measurement system to capture an image of an eye, according to at least one embodiment described in the present disclosure.

At block 810, the image capture procedure is initiated. For example, a medical professional may initiate the image capture procedure to, e.g., measure the topography of the eye.

At block 812, the camera of the camera system is turned on. The camera may be turned on in preparation to capture an image of the eye.

At block 814, the pattern illuminator is turned on. The pattern illuminator may be turned on in preparation to illuminate the eye with the pattern.

At block 815, the distance measurement system is turned on. The distance measurement system may be turned on in preparation to measure the distance to the eye.

At block 816, the alignment detector is initiated. Any suitable alignment detector may be used, e.g., a detector as described with reference to block 716 of FIG. 7.

At block 818, the eye is detected to be aligned. The eye may be detected to be aligned in any suitable manner, e.g. in a manner described with reference to block 718 of FIG. 7.

At block 820, the pattern illumination, the distance measurement, and the image capture are initiated.

At block 822, the pattern illuminator illuminates the eye.

At block 823, the distance measurement system measures the distance to the eye.

At block 824, the camera captures an image of the eye illuminated by the pattern. Block 822, block 823, and block 824 may occur simultaneously. Additionally or alternatively, the capturing of the image, the illuminating the eye with the pattern, and the measuring the distance to the eye may occur within a threshold amount of time with each other, such as within 0.25 milliseconds (ms), 0.5 ms, 0.75 ms, 1 ms, 5 ms, or within any other threshold amount of time.

At block 826, the image capture may be successful. An image capture may be determined to be successful in any suitable manner, e.g., in a manner as described with reference to block 626 of FIG. 6. If the image capture is not successful, the method returns to block 816. If the image capture is successful, the method proceeds to block 828.

At block 828, the distance measurement may be successful. In certain embodiments, the distance measurement system may check whether the eye is at the proper distance for the image capture procedure. In certain embodiments, the proper distance may be within a focal range of one or more cameras of a camera system, such as a distance within a range of 0.5 to 30 centimeters (cm), e.g., 0.5 cm to 5 cm, 5 cm to 10 cm, 10 cm to 20 cm, and/or 30 cm to 30 cm. If the distance measurement is not successful, the method returns to block 816. If the distance measurement is successful, the method proceeds to block 830.

At block 830, the camera is turned off.

At block 832, the pattern illuminator is turned off.

At block 834, the distance measurement system is turned off.

The present disclosure (including the specification, claims, and drawings) includes example embodiments that are intended to aid the reader in understanding the invention and concepts contributed by the inventor to furthering the art and to enable any person skilled in the art to make or use the disclosed embodiments. Modifications (e.g., changes, substitutions, additions, omissions, and/or other modifications) to the embodiments will be readily apparent to those skilled in the art. Accordingly, modifications may be made to the embodiments without departing from the essence of the present disclosure.

In certain instances, modifications may be made to the systems disclosed herein, as apparent to those skilled in the art. For example, parts of a system may be integrated or separated, or an operation of a system may be performed by more, fewer, or other parts. In certain instances, modifications may be made to the methods disclosed herein, as apparent to those skilled in the art. For example, the methods may include more, fewer, or other operations. As another example, certain operations may be optional, combined into fewer operations, or expanded into additional operations. As yet another example, certain operations may be performed in any suitable order or simultaneously.

Furthermore, those skilled in the art will recognize that the present disclosure is not intended to be limited to the example embodiments and that the language of the disclosure is to be accorded the widest scope consistent with the present disclosure. Terms (which may include one or more words) that describe inclusion are generally intended as “open” terms in that they generally do not imply exclusion. For example, the term “including” may be interpreted as “including, but not limited to” or “including at least”; the term “having” may be interpreted as “having, but not limited to” or “having at least”; and the term “comprising” may be interpreted as “comprising, but not limited to” or “comprising at least”, etc.

Additionally, if a specific number is intended, such intent will be explicitly recited in the claim. In the absence of the explicit recitation of a specific number, no such intent is present. If a specific number is explicitly recited, such recitation should be interpreted to mean at least the recited number. For example, the bare recitation of “two Xs”, without other modifiers, may mean “at least two Xs” or “two or more Xs”. Moreover, the use of an indefinite article (e.g., “a” or “an”) or definite article (e.g., “the”) to introduce a noun phrase should not be construed to limit the noun phrase to one, but may be interpreted as an open term “at least one” or “one or more”. This holds even when the same claim includes an open term (e.g., “one or more” or “at least one”) and an indefinite or definite article (e.g., “a” or “an” or “the”).

Moreover, a selection from a list of items should be understood to contemplate a selection of any suitable individual item or any suitable combination of items. For example, the general construction “at least one of A, B, and C” or “one or more of A, B, and C” may include A alone; B alone; C alone; A and B together; A and C together; B and C together; and A, B, and C together. Moreover, any disjunctive term presenting two or more alternative items may be understood to contemplate including one of the items, either of the items, or both items. For example, the general construction “A or B” or “A and/or B” may include A alone, B alone, and A and B together. Additionally, the use of the terms “first,” “second,” “third,” etc. are not necessarily used herein to connote a specific order. For example, the terms “first,” “second,” “third,” etc., may be used to distinguish between different elements.

Additionally, relative terms may be used and understood as typically used in the relevant art. By way of example, relative terms such as “approximately,” “substantially,” “about,” “roughly,” or other similar relative terms mean the specified value or the specified value and a reasonable amount of deviation from the specified value (e.g., a deviation of up to ±0.1%, ±1%, ±5%, or ±10%, as such variations are appropriate) such that the end result is not significantly or materially changed. For example, “about 1.0 cm” can be interpreted to mean “1.0 cm” or between “0.9 cm and 1.1 cm.” When such relative terms are used to refer to numbers or values that are part of a range, the term can be used to modify both the minimum and maximum numbers or values.

To aid the Patent Office and readers in interpreting the claims, Applicants note that they do not intend any of the claims or claim elements to invoke 35 U.S.C. §112(f), unless the words “means for” or “step for” are explicitly used in the particular claim. Use of any other term (e.g., “mechanism,” “module,” “device,” “unit,” “component,” “element,” “member,” “apparatus,” “machine,” “system,” “processor,” or “controller”) within a claim is understood by the Applicants to refer to structures known to those skilled in the art and is not intended to invoke 35 U.S.C. §112(f).

What is claimed:

1. A system configured to illuminate an eye, comprising:
a pattern illuminator configured to provide an illumination pattern directed towards an anterior surface of the eye, the anterior surface of the eye reflecting the illumination pattern as a reflected illumination pattern; and
an illuminator computer configured to:
receive, via a wireless communication link, a set of instructions configured to coordinate the illumination pattern with a device of one or more devices of an ophthalmic system; and
instruct the pattern illuminator to provide the illumination pattern according to the set of instructions to coordinate the illumination pattern with the device of the one or more devices of the ophthalmic system.

2. The system of claim 1:
the device of the one or more devices of the ophthalmic system comprising a camera system configured to capture an image of the reflected illumination pattern; and
the illuminator computer configured to instruct the pattern illuminator to provide the illumination pattern when the camera system is capturing the image of the reflected illumination pattern.

3. The system of claim 1:
the device of the one or more devices of the ophthalmic system comprising an eye-tracker configured to track a movement of the eye; and
the illuminator computer configured to instruct the pattern illuminator to not provide the illumination pattern when the eye-tracker is tracking the movement of the eye.

4. The system of claim 1:
the device of the one or more devices of the ophthalmic system comprising an eye-tracker configured to track a movement of the eye; and
the illuminator computer configured to instruct the pattern illuminator to not provide the illumination pattern when the eye-tracker is providing an eye-tracking light.

5. The system of claim 1:
the device of the one or more devices of the ophthalmic system comprising a laser system configured to direct a laser beam towards the eye; and
the illuminator computer configured to instruct the pattern illuminator to not provide the illumination pattern when the laser system is directing the laser beam towards the eye.

6. The system of claim 1:
the set of instructions comprising a notification that the device of the one or more devices is operating; and
the illuminator computer configured to instruct the pattern illuminator to not provide the illumination pattern in response to the notification that the device of the one or more devices is operating.

7. The system of claim 1:
the set of instructions comprising a notification that the device of the one or more devices is operating; and
the illuminator computer configured to instruct the pattern illuminator to provide the illumination pattern in response to the notification that the device of the one or more devices is operating.

8. The system of claim 1:
the one or more devices of the ophthalmic system comprising:
a camera system configured to capture an image of the reflected illumination pattern; and
an alignment detector configured to detect that the eye is aligned with the ophthalmic system; and
the illuminator computer configured to instruct the pattern illuminator to provide the illumination pattern when:
the camera system captures the image of the reflected illumination pattern; and
the alignment detector detects that the eye is aligned with the ophthalmic system.

9. The system of claim 1:
the one or more devices of the ophthalmic system comprising:
a camera system configured to capture an image of the reflected illumination pattern; and
a distance measurement system configured to measure a distance to the eye; and
the illuminator computer configured to instruct the pattern illuminator to provide the illumination pattern when:
the camera system captures the image of the reflected illumination pattern; and
the distance measurement system measures the distance to the eye.

10. The system of claim 1, the illuminator computer comprising:
a transceiver configured to receive, via the wireless communication, the set of instructions.

11. The system of claim 1, the illuminator computer configured to communicate, via the wireless communication, with a system computer of the ophthalmic system.

12. The system of claim 1, the pattern illuminator comprising:
one or more illuminator rings, each illuminator ring of the one or more illuminator rings configured to provide a circular illumination pattern.

13. The system of claim 1:
the pattern illuminator comprising a plurality of pixel illuminators, each pixel illuminator of the plurality of pixel illuminators configured to provide light; and
the illuminator computer configured to turn on at least a subset of the plurality of pixel illuminators to yield the illumination pattern.

14. The system of claim 1, further comprising the ophthalmic system, the ophthalmic system configured to:
generate an image of the reflected illumination pattern;
perform an analysis of the image of the reflected illumination pattern; and
generate a description of the eye according to the analysis of the image of the reflected illumination pattern.

15. The system of claim 14, the description of the eye describing a curvature of the anterior surface of the eye.

16. The system of claim 14, the description of the eye comprising a topographic image describing a curvature of the anterior surface of the eye.

17. The system of claim 1, further comprising a display device, the display device configured to display a graphical user interface configured to receive an input for the set of instructions.

18. The system of claim 17, the graphical user interface comprising:
an illuminator pattern selector configured to receive a selection of a pattern for the illumination pattern.

19. The system of claim 17, the graphical user interface comprising:
a manual control selector configured to receive a manual control selection to provide the illumination pattern in response to a manual command.

20. The system of claim 17, the graphical user interface comprising:
a device selector configured to receive a first selection of the device of the one or more devices of the ophthalmic system to be coordinated with the illuminator computer; and
a turn on / turn off selector configured to receive a second selection to coordinate the illumination pattern with the device of the one or more devices of the ophthalmic system.
